(19) United States
(12) Patent Application Publication
(10) Pub. No.: US 2008/0251318 A1
(43) Pub. Date: Oct. 16, 2008

(54) Tree stand shelf

(76) Inventor: Susan Ann Dudonis, Howell, MI (US)

Correspondence Address: Susan Ann Dudonis, 3755 Mason Road, Howell, MI, 48843, US

(21) Appl. No.: 12/082,594

(22) Filed: Apr. 11, 2008

Related U.S. Application Data
(60) Provisional application No. 60/912,127, filed on Apr. 16, 2007.

(51) Int. Cl. A01M 31/02

(52) U.S. Cl. 182/150

(57) ABSTRACT

A shelf-like platform which is mountable to the side of the seat of a hunter's existing, commercially manufactured tree stand. The invention consists of a shelf-like platform, a stabilizing bar and connecting devices, such as brackets, U-bolts and wing nuts. The platform is used to set items on while the user is in the stand. The connecting devices are used for holding the device into place on the side of the existing tree stand's seat. The stabilizing bar secures the platform in place and keeps the platform level.

This application is a continuation of the provisional application 60/912,127 filed on Apr. 16, 2007.

### BACKGROUND OF THE INVENTION

Tree stands are used by people to view and observe nature for various reasons, including, but not limited to, hunting, bird watching and photography. People use tree stands to view nature without nature being able to obviously view them. Often, it takes a lot of time to let nature settle back into itself after persons have moved through in order to take the stand. To allow the most time to observe without having to leave the stand, being comfortable often involves being able to set down at close proximity, items such as binoculars, gloves, snacks, etc.

A wide variety of tree stands are currently available, many containing a ladder, a seat and a foot pad, for the user to sit or stand on while waiting for wildlife to appear. Most manufactured tree stands are designed to be light weight, easy to transport and setup, but have very little or no room at all for placement of personal articles; such as gloves, binoculars, cameras, snacks, etc.

Various products comprised of hooks, bags or ropes have been created in order to allow users of tree stands a place to put their personal articles; however, these products typically rely on a well placed tree branch, large tree trunk or belt-like connection. Yet other products, such as in U.S. Pat. No. 6,205,935-Lindaman, rely on penetration of the tree's bark in order to work. With these products, oftentimes, the user must twist, turn or reach in order to obtain the desired article, possibly causing them to lose their balance or otherwise bring undesired attention to themselves. Also, care must be taken to ensure the article actually enters the bag or attaches to the hook or rope, so it does not fall, and again, bring undesired attention to themselves. Having an easily available, close place to set items is a premium, especially if there is a need to set something down quickly.

### SUMMARY OF THE INVENTION

This invention helps create a safer and more comfortable experience for a tree stand user, by allowing them a place to quickly, quietly, and safely set their personal articles within easy reach. The invention does not require any penetration of tree bark; and, therefore, can be used in areas where such actions are not permitted. No tools are required for installation of the invention. The invention connects directly to the side of the already placed tree stand's seat, thereby reducing safety and/or unwanted attention issues caused by excessive reaching, twisting or turning.

This invention concerns a light-weight, shelf-like platform which is attached directly to the side of a user's existing tree stand's seat, thereby allowing a user a place to safely, easily and quickly set and retrieve their personal articles.

This invention is lightweight and easy to transport to the tree stand site, as well as easy to attach to the existing tree stand.

No tools are required for the installation of this invention.

This invention is not reliant on having a well-placed tree branch or large tree trunk in order to work properly.

No penetration of tree bark is required for use of the invention.

This invention is ambidextrous, attaching to either side of the seat, allowing use for both left and right handed persons, or can even be used in tandem.

### BRIEF DESCRIPTION OF THE DRAWINGS

FIG. 1 is a perspective view of a typical, commercially manufactured ladder style tree stand with the tree stand shelf unit attached;

FIG. 2 is a top view of the invention, illustrating the tree stand shelf, connecting brackets and stabilizing bar;

FIG. 3 is a bottom view of the invention, further illustrating the tree stand shelf, connecting brackets and stabilizing bar.

### DETAILED DESCRIPTION

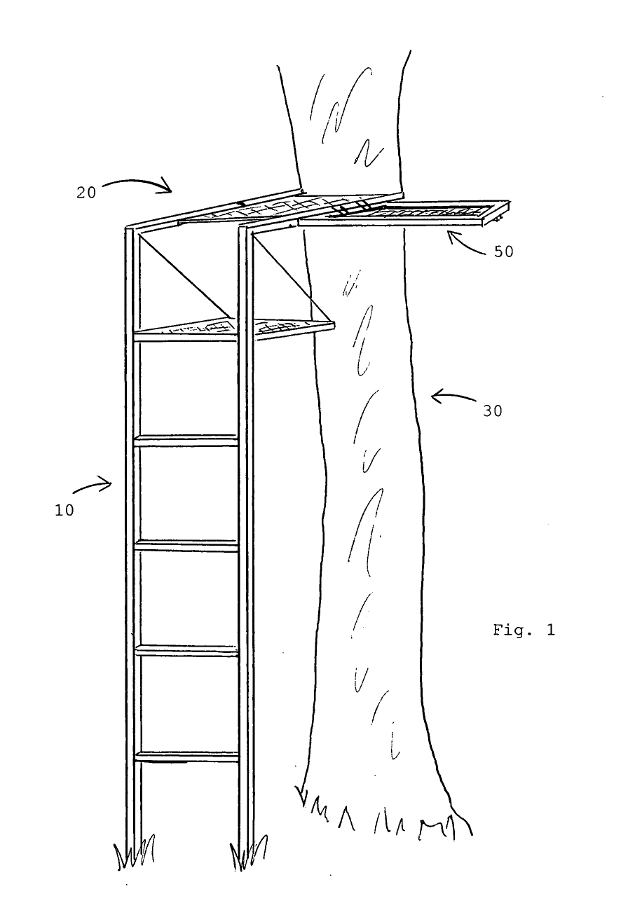

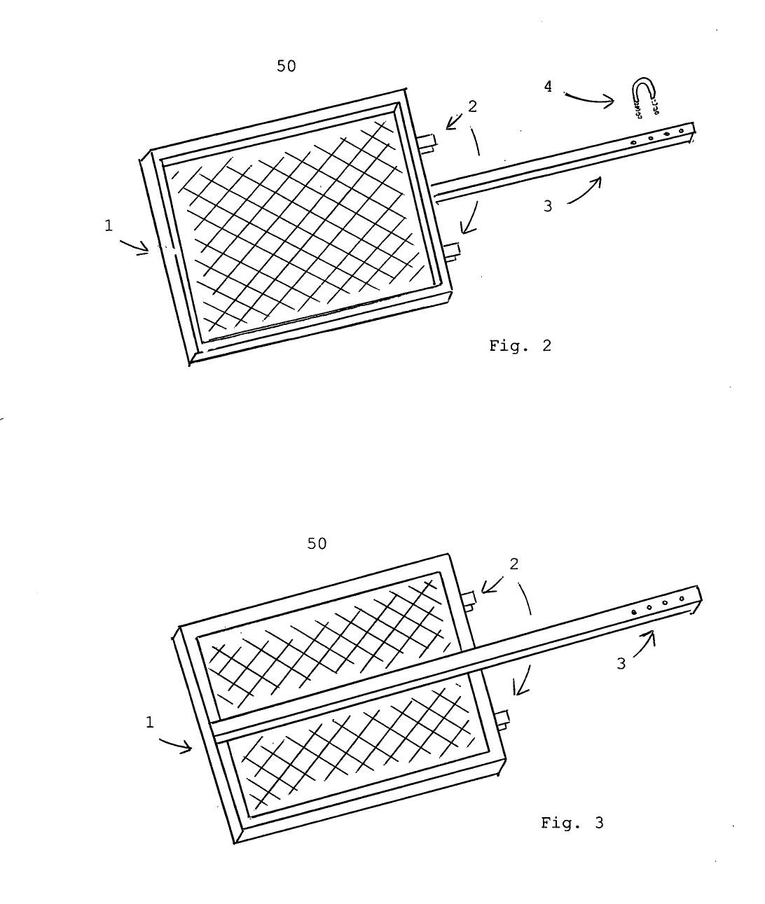

With reference now to the accompanying drawings, and in particular to FIGS. 1 through 3 thereof, a new tree stand shelf unit embodying the principles and concepts of the present invention and generally designated by the reference numeral 50 will be described.

The present invention includes a platform, preferably, but not necessarily, having a raised edge and grated bottom, designated as numeral 1; two attachment devices, such as brackets, designated as numeral 2; a stabilizing bar, preferably with adjustment capabilities, designated as numeral 3; and a third attachment device, such as a U-bolt with wing nuts, designated as numeral 4, connects the stabilizing bar to the opposite side of the seat of the existing tree stand.

A person attaches a typical, commercially manufactured tree stand, designated as numeral 10, to a tree, designated as numeral 30. Once the tree stand is safely attached to the tree, the tree stand shelf unit, designated as numeral 50, can then be attached to the seat, 20, of the tree stand.

A person climbs the tree stand's ladder, 10, carrying the shelf unit, 50. While standing on the tree stand's ladder, 10, facing the tree, 30, the connecting brackets, 2, of the present invention are slipped into place on the sidebar of the seat, 20, on whichever side of the stand's seat the user desires. Once the platform is in place on the side of the tree stand's seat, the stabilizing bar, which runs across the bottom of the seat of the tree stand, is secured into place, to the opposite side of the tree stand's seat, with the third connecting device, such as a U-bolt and wing nuts, 4. The tree stand shelf is now installed and ready for use.

With respect to the above description, it is realized that the optimal dimensional relationships for the parts of the invention, to include variations in size, materials, shape, form, function and manner of operation, assembly and use are deemed readily apparent and obvious to one skilled in the art, and all equivalent relationships to those illustrated in the drawings and described in the specification are intended to be encompassed by the present invention.

Therefore, the above description is intended for illustration only of the principles of the invention. Further, since numerous modifications and changes will readily occur to those skilled in the art, it is desired the invention not be limited to the exact construction shown and described, and accordingly, all suitable modifications and equivalents may be resorted to, falling within the scope of the invention.

What is claimed is:

1. A tree stand attachment comprising, in combination:
a shelf-like platform, preferably having a raised edging and preferably a grated or otherwise drainable bottom;
a set of connecting devices which are deep enough to span the width of the side bar of a typical tree stand, approximately 1.25 inches, and long enough to extend over the edge of the tree stand's seat, approximately 1.5 inches;
a preferably, but not necessarily, adjustable stabilizing bar, which will extend from the side of the platform and be able to span across the bottom of the seat of the tree stand;
and a third connecting device, such as a U-bolt with wing nuts, used for securing the end of the stabilizing bar itself to the opposite side of the existing tree stand's seat.
